(19) United States
(12) Patent Application Publication
(10) Pub. No.: US 2005/0065842 A1
(43) Pub. Date: Mar. 24, 2005

(54) System and method for coordinating product inspection, repair and product maintenance

(76) Inventor: Richard Summers, Portsmouth, NH (US)

Correspondence Address: BOURQUE & ASSOCIATES, P.A.;Suite 301, 835 Hanover Street, Manchester, NH, 03104, US

(21) Appl. No.: 10/900,981

(22) Filed: Jul. 28, 2004

Related U.S. Application Data
(60) Provisional application No. 60/490,574, filed on Jul. 28, 2003.
(60) Provisional application No. 60/492,075, filed on Aug. 1, 2003.

(51) Int. Cl. G06F 17/60

(52) U.S. Cl. 705/11; 705/1

(57) ABSTRACT

A system and method for coordinating product inspection, repair and product maintenance features a proactive, data-driven process where industry-wide maintenance baselines, problems, frequency-of-occurrence data and best-in-class repair processes are identified in a central, secure, structured database environment and thereby where the safety and operational and economic impact of a problem can be evaluated and acted upon. Using industry-wide data provided by users, the present system and method will link repair and inspection finds (non-routines), reason codes and severity data related to potential safety, reliability, cycle time and cost implications with the root cause analysis and certified best inspection/repair/preventative process instructions, materials, tools and/or equipment. This information, combined with a maintenance provider's, manufacturer's and OEM's information, will greatly improve safety, reliability, cycle time and budget performance on repair, maintenance and inspection of equipment utilizing the present system and method.

### RELATED PRIOR APPLICATION AND PRIORITY CLAIM

The present application claims priority from U.S. Provisional Application No. 60/490,574 filed Jul. 28, 2003 and U.S. Provisional Application No. 60/492,075 filed Aug. 1, 2003

### FIELD OF THE INVENTION

The present invention relates generally to standardized procedures and information systems and more particularly, to a system, information system and method for ensuring that product maintenance, inspection and repair takes into account multiple (cross-organizational) sources of information.

### BACKGROUND OF THE INVENTION

Many industries, such as the airline industry, have rigorous maintenance requirements to ensure safety. Maintenance may be scheduled or special (the result of a problem, failure or breakdown of mandated changes).

During maintenance of such products, there is a standard maintenance baseline developed by the manufacturer, customized by the owner and sometimes mandated by governmental authorities, that identifies all required inspection and repair requirements. The accuracy of the standard maintenance baseline is essential to ensure that all inspection and repair items are identified and accomplished in a high quality, safe and productive manner.

All problems related to any maintenance activity can have an associated cost of quality, which could include a negative impact on safety, reliability and productivity (i.e. cycle time and cost).

The prior art of current maintenance process overview 100, FIG. 1, depicts the environment of a typical, prior art maintenance, inspection and repair operation. The airline industry is used here for exemplary purposes only.

For each type of aircraft produced, each Aircraft Manufacturer develops a Scheduled Maintenance Program or Standard Maintenance Baseline for various types and levels of maintenance events from in-service checks to call letter checks to a Heavy Maintenance Visit (HMV), 110. It is the Certified Standard Baseline that serves as the basis for defining all maintenance activities for a specific aircraft and a specific type of maintenance event.

In a process called “Aircraft Certification”, the Aircraft Manufacturer and Aircraft Owner develop an airline-specific Certified Maintenance Baseline, based on the manufacturer's Standard Maintenance Baseline, which must be used for all maintenance inspection and repair activities, 120.

As a part of a maintenance event, inspection and repair activities take place where problems (Non-routine maintenance) are identified, reported and stored, 130, in a Non-routine database, 140. All Non-routines must be corrected and signed off as having been completed before a maintenance event can be signed off as completed.

As a part of a maintenance event, Routine tasks are also completed and signed off as having been completed, 150.

In-service/flight problems are reported back to Base Maintenance and are corrected, depending on the nature of the problem before the next flight departs, as part of an overnight repair or at the next service check, 160.

The Aircraft Owner maintains its Maintenance Baseline through its own internal change control procedures, 170.

In the event of an aircraft accident or incident, a regulator agency (FAA) or review board (NTSB) investigates the cause of the accident/incident and provides corrective action back to the aircraft manufacturer and all aircraft owners based on evidence from the investigation of the accident or incident, 180.

Quite frequently, the adequacy of the process to maintain a high quality standard maintenance baseline is in question, especially when one considers cross-organizational differences. In many cases, there is no effective feedback loop for inspector(s) or mechanic(s) to share their experience regarding improvements in the repair and inspection process, error detection and frequency-of-occurrence data. If this condition exists within an organization, it is even more difficult to share critical maintenance information and data across different airlines or with the Aircraft Manufacturer. This condition can result in the loss of critical safety-related information, which could lead to the condition where maintenance baselines are missing critical information, creating an unsafe condition. At the same time valuable productivity information is also lost.

In many cases when Non-routines (non-routine maintenance) are detected as a result of the inspection process, there are no certified proven repair processes to correct the situation. Due to time constraints, the new repair process may not incorporate the best repair processes, leading to unsafe conditions, and usually results in additional costs and delays in the repair process.

If the accuracy of the maintenance baseline and the availability of frequency-of-occurrence data associated with the inspection process are in question, the repair process is greatly dependent on the experience level of the mechanics and inspectors. Within this type of environment many inspectors and mechanics have to complete their tasks based on their experience. This situation creates a condition where information about improved repair practices, parts failures, frequency-of-occurrence data and other information that is known and perhaps collected in various databases, but not collected and indexed in a useable manner, are not available or shared within an organization or across other organizations.

In today's environment, the inspection and repair process is greatly dependent on the experience level of the inspectors and mechanics. With the current economic climate and the trend to downsize and outsource the maintenance process, many senior inspectors and mechanics are taking early retirement. This situation can present a serious problem.

The sharing of these types of information and data across organizations in an organized manner is rare to nonexistent. This condition can result in the loss of valuable improvement ideas, data or problems found information associated with the operation of the equipment and the maintenance process. Where critical safety-related problems are detected and corrected in one organization, another organization may not be aware of the problem at all, which could create and has created a critical, unsafe condition. Analysis of accident data has proven this situation can result in a catastrophic event. At which point, hopefully, the error is detected and corrective action taken. This is done through safety directives published usually by a regulatory agency or manufacturer, but tragically, only after a loss of life and/or property.

These problems are usually not quality of work problems; they are quality of process problems. To have a high quality, safe and productive maintenance process there must be highly trained and experienced maintenance personnel, a high quality information feedback process and an efficient change control process that creates a continuous improvement, prevention-driven environment that is shared on a continuous basis within an organization and across other Owner/Operators, Manufacturers and Strategic Suppliers.

Accordingly, a need exists for a system and method implementing standardized procedures and information systems for ensuring that product maintenance, inspection and repair takes into account multiple (cross-organizational) sources of information, thereby providing a method to continuously improve safety and quality of the product itself, the product standard maintenance baseline, and the product inspection and repair process.

### SUMMARY OF THE INVENTION

The present invention features a proactive, data-driven process based on Six Sigma practices where industry-wide maintenance baselines, problems, repairs, frequency-of-occurrence data and best-in-class repair processes and the like are identified in a central, secure, structured database environment and thereby where the safety and operational and economic impact of a problem can be evaluated and acted upon.

With frequency-of-occurrence data, solutions to maintenance problems on an individual aircraft or piece of machinery have a high probability of applying across a fleet type, across other airlines and across other fleets. By sharing information in a win-win environment, the present invention will increase the speed by which the airline industry or other equipment manufacturers can improve safety, reliability, quality and operational effectiveness.

Users of the present invention, (i.e. Aircraft Maintenance Providers, Aircraft Manufacturers, OEM's and Strategic Suppliers from across the world), working together in a win-win environment will share resources to develop certified best repair and preventative processes, materials, tools and equipment solutions for routine, non-routine and Airworthiness Directive work efforts. Fleet-specific best-in-class repair processes structured to specific work efforts will be available to AIMIS Aircraft Maintenance Providers, Aircraft Manufacturers and OEM's.

A multi-strategic supplier network allows system users and Maintenance Providers to take advantage of technologies, research and development, products and services that far exceed the resources or capabilities of an individual Aircraft Maintenance Provider. With combined reliability and frequency-of-occurrence data generated from multiple airlines including root cause analysis and best-in-class repair processes, Aircraft Maintenance Providers, Aircraft Manufacturers and OEM's can benchmark the effectiveness of their product design, manufacturing and repair processes and focus on high-impact corrective actions, accelerating their path to world-class performance.

Users and Maintenance Providers can combine AIMIS Strategic Suppliers' alternative best-in-class repair processes with their own best practices to accelerate improvements in safety, reliability and overall productivity and cycle time of their maintenance process. During the inspection process, downloading the frequency-of-occurrence inspection data to a hand-held computer will greatly improve the quality of the inspection process, minimizing the risk of inspector errors. Each Inspection Activity will generate an electronic record including a reason code and severity data.

Using industry-wide data provided by users, the present system and method will link inspection finds (non-routines), reason codes and severity data related to potential safety, reliability, cycle time and cost implications with the root cause analysis and certified best inspection/repair/preventative process instructions, materials, tools and/or equipment. This information, combined with an Aircraft Maintenance Provider's, Aircraft Manufacturer's and OEM's information will greatly improve safety, reliability, cycle time and budget performance.

Business-to-Business Internet capabilities will provide for materials, tools and/or equipment to be supplied to a repair site on a just-in-time basis, minimizing inventory and transaction costs associated with ordering and expediting materials, tools and equipment. Membership or subscription to the system and method of the present invention will provide all Aircraft Maintenance Providers, Aircraft Manufacturers and OEM's, large or small, across the world with an opportunity to achieve the highest levels of safety, reliability, quality and operational effectiveness. Strategic Suppliers have the opportunity to make their technologies, products and services available to Aircraft Maintenance Providers across the world not as general information, but as solutions to specific maintenance problems, thus opening revenue channels that would have otherwise been more difficult and costly to penetrate.

Providing reliability and frequency-of-occurrence data as well as root cause analysis and best-in-class repair processes back to an AIMIS Aircraft Manufacturer or Original Equipment Manufacturer (OEM) suppliers will provide extremely valuable design, manufacturability and maintainability information for them to improve the overall safety, reliability and quality of their products. AIMIS Strategic Suppliers will have an opportunity to open additional revenue streams to have their products and services built into the aircraft Manufacturer's Maintenance Provider's and OEM Suppliers' Bill of Material.

This win-win environment will make the airline industry, for example, the safest, highest quality, and operationally efficient industry in the world. As with AIMIS Aircraft Maintenance Providers, AIMIS Aircraft Manufacturers and OEM Suppliers can take advantage of technologies, research and development, products and services that far exceed the resources and capabilities of an individual Aircraft Manufacturer or OEM Supplier.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a flow chart illustrating the current, prior art maintenance process overview;

FIG. 2 is a block diagram of a system according to the present invention;

FIG. 3 is a flow chart that describes the continuous improvement, maintenance and change control of a Manufacturer's Standard Maintenance Baseline and the Aircraft Owner's Maintenance Baseline, based on the feedback of safety and productivity information to and from each party in a multi-organizational environment in accordance with the teachings of the present invention;

FIG. 4 is a flow chart that describes the process of utilizing frequency-of-occurrence data for review and update in accordance with one feature of the present invention;

FIG. 5 is a table that shows an example of a system's architecture and system interfaces for the airline industry;

FIG. 6 is an example of a maintenance data structure for the airline industry;

FIGS. 7A-7C are a table of terms and definitions related to airline inspection activity; and

FIGS. 8A and 8B are a flow chart of the Data Analysis and Authorized Repair Process for a Standard/Aircraft Improvement Initiative (S./A.I.I.) implementation in accordance with the present invention.

### DETAILED DESCRIPTION OF THE PREFERRED EMBODIMENTS

In a cross- or multi-organization environment, the sharing of best-in-class repair and inspection processes and frequency-of-occurrence data will greatly improve not only safety but also productivity. Problems found with the maintenance repair and inspection process, the availability to use frequency-of-occurrence data and the development of certified best-in-class repair processes that are shared across organizations will be beneficial to all involved organizations. Accordingly, there is a need for a controlled system and method that can collect and organize many pieces of information and tie various databases together providing a novel system and method to organize product maintenance, repair and inspection information and data. Although the present invention will be explained in the context of an airline maintenance and repair system, this is for exemplary purposes only, and not a limitation on the present invention, which can be used in every field on any type of product or process. The present invention will be explained using standard maintenance repair, inspection and diagnostic activities including in-service/use aircraft, problems found including frequency-of-occurrence information, non-routine repair, Change Orders and Regulatory Directives activities.

Further, the present invention will sometimes be referred to as using the acronym “IMIS”, which is trademark of the assignee of the present invention for its “Industry Maintenance Information System” maintenance system and method which operates in accordance with the teachings of the present invention or “AIMIS” which is trademark of the assignee of the present invention for its “Airline Industry Maintenance Information System” maintenance system and method which operates in accordance with the teachings of the present invention.

The present invention is a Six Sigma, data-driven process to significantly improve safety, reliability, quality of service and operational effectiveness in a prevention-driven and productive maintenance environment. It is comprised of three parts:

1. An industry-wide Standard Maintenance Baseline and frequency-of-occurrence database that is under continuous improvement and is used to identify and prioritize problems by category/type for safety, reliability, severity, cost and cycle time reasons;

2. A process by which Maintenance Providers, Strategic Suppliers and Manufacturers/OEMs jointly conduct root cause analysis and develop prevention-driven, best-in-class repair processes to reoccurring problems; and

3. A technology-driven method to standardize data definition and improve the accuracy and productivity of the process of data collection, retrieval, analysis and use.

One goal of the present invention is to continuously improve safety, reliability, quality and operational effectiveness of the airline or other industry by providing a current, 100% correct Standard Maintenance Baseline, combined secure frequency-of-occurrence data and certified, best-in-class repair processes to airlines, Aircraft Manufacturers, Maintenance Providers and Strategic Suppliers worldwide.

The present invention strives to create an environment where safety, compliance and reliability will never be compromised and whereby safety, reliability, quality of service and operational effectiveness of the airline or other equipment driven industry maintenance process will be greatly improved. The present invention will set design requirements for information technology to better collect, store, analyze and use Standard Maintenance Baselines and frequency-of-occurrence data and will create an industry-wide current high quality Standard Maintenance Baseline, where changes are controlled through a process based on root cause analysis and best-in-class repair processes, which are certified and stored in a Standard Maintenance Baseline and shared by Maintenance Providers, Aircraft Manufacturers, OEMs and Strategic Suppliers.

The present invention will also strive to create an industry-wide, problem-based frequency-of-occurrence database to greatly improve the inspection process of problem identification and recording through the use of industry-wide frequency-of-occurrence data and will focus and share research and development resources and technologies on reoccurring, known safety problems to develop certified, best-in-class repair processes that are shared across all Maintenance Providers, Aircraft Manufacturers and OEMs to greatly improve airline safety and reliability while improving the cycle time and reducing cost and of the overall maintenance process.

The present invention is applicable to any type of maintenance activity, whether commercial, public and/or military. It includes, but is not limited to the following industries: transportation, which includes aircraft, automobiles, ships, trains and buses; heavy construction equipment; manufacturing equipment; power generation and transmission equipment; and electronic equipment, which includes computer-related equipment, medical equipment and other types equipment.

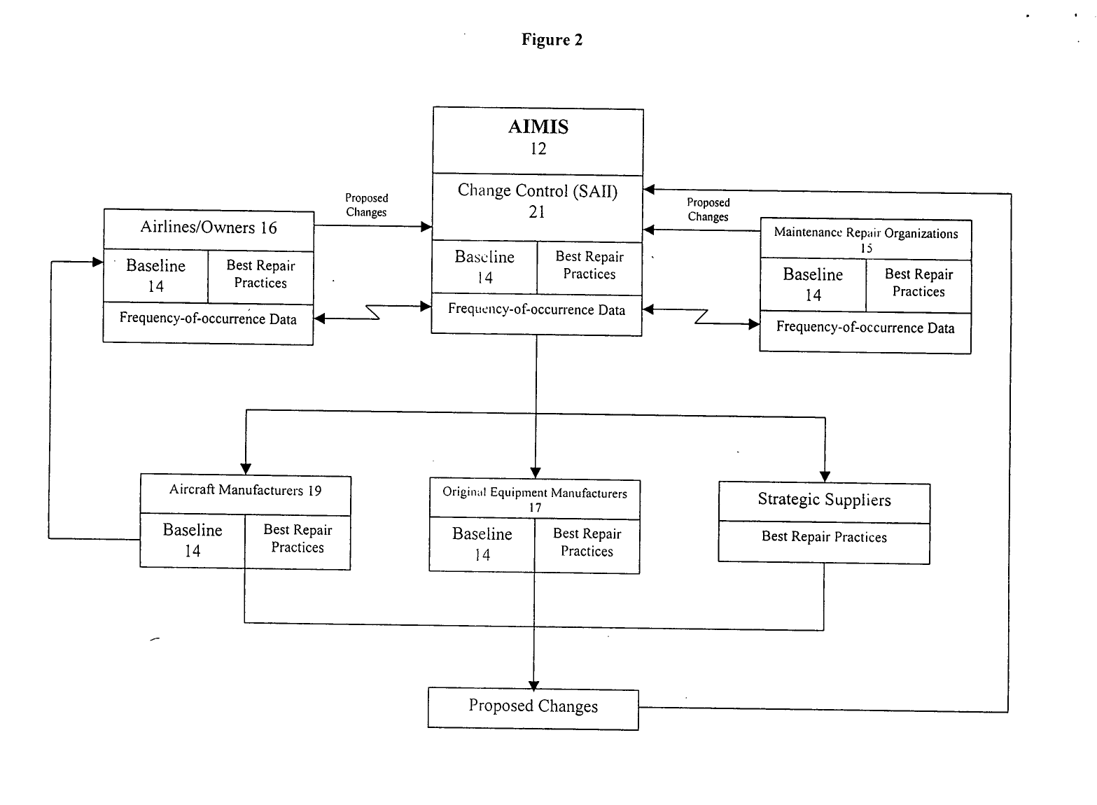

The present invention is shown generally at 10, FIG. 2, and includes a processing engine 12 which receives and contains, as input, industry standard or Baseline information 14, and user information from one or more industry sources 15-19 such as safety, reliability, repair, accident and productivity information. The present invention contemplates a central location for the processing engine 12 with various types of inputs disbursed geographically depending upon the industry in which the present invention is deployed. For example, user group 16 may be a collection of one or more repair facilities for one Airline while user group 15 may be a collection of information from one or more repair facilities from a different Airline. All of this information is gathered by various means, well known to those skilled in the art, and collectively referred to as user information. User information may include, but is not limited to, repair and maintenance information, deviation from industry standard information, frequency-of-occurrence information, in-service problems discovered independently, and the like.

Industry-specific information will and may be received independently from user information and may include but is not limited to information received from manufacturers 19, governmental, regulatory and investigative agencies 18, subcontractors and the like. Baseline safety and Best Practice solutions developed by various user groups will be shared through the use of an internal and industry-wide change process (SAII) 21.

The change control process 19 of the present invention will receive and analyze all proposed changes to the standard baseline, and determine what impact those proposed change have on the standard baseline information 14. If the change control process 19 determines that any of the proposed changes do have an impact on the industry standard information or baseline 14, the change control process 19, may determine that a change to the industry standard baseline information 14 should be adopted and promulgated. The approved change information is routed or transmitted back to the user groups 15-19 for consideration of adapting the proposed changes to their own respective baselines using their own change control processes. In this manner, standard baseline information which is available to all users is constantly updated with information to reflect repair history, accident history and other problems or influences on machinery and equipment in service on a day-to-day basis. It is through this process that all users are notified of changes to the standard.

It is contemplated that the processing engine 12 in accordance with the present invention be implemented in computer hardware and software, although that is not a limitation of the present invention. It is contemplated that the centrally located processing engine 12 be connected by means of one of a variety of computer connections to various users and providers of necessary input information.

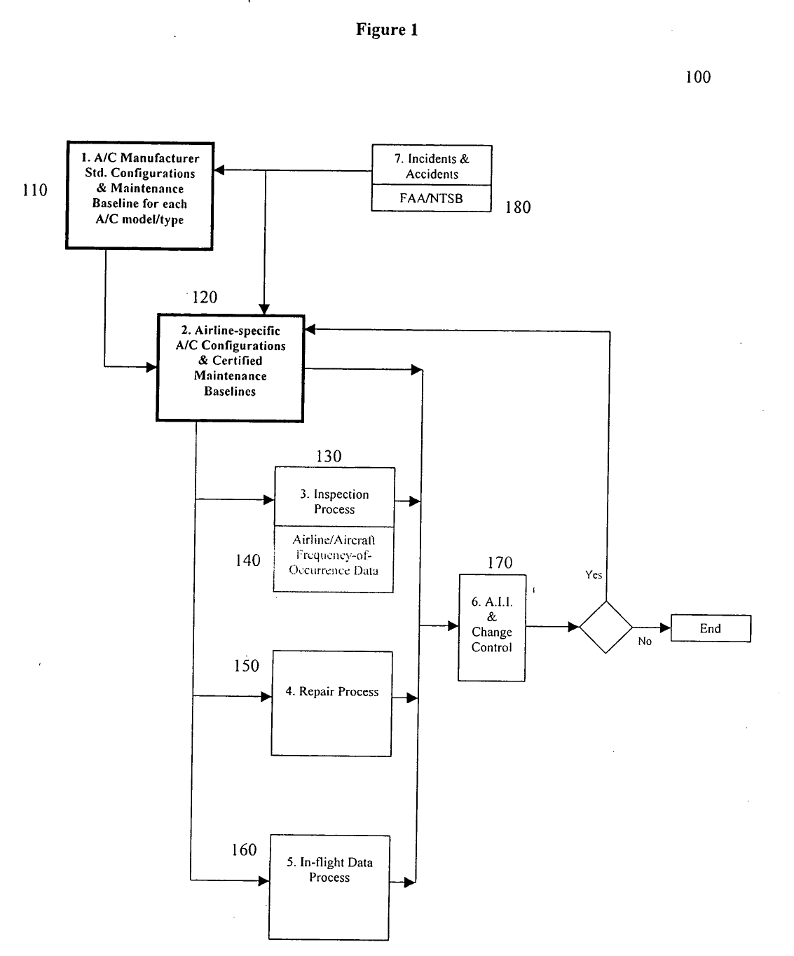

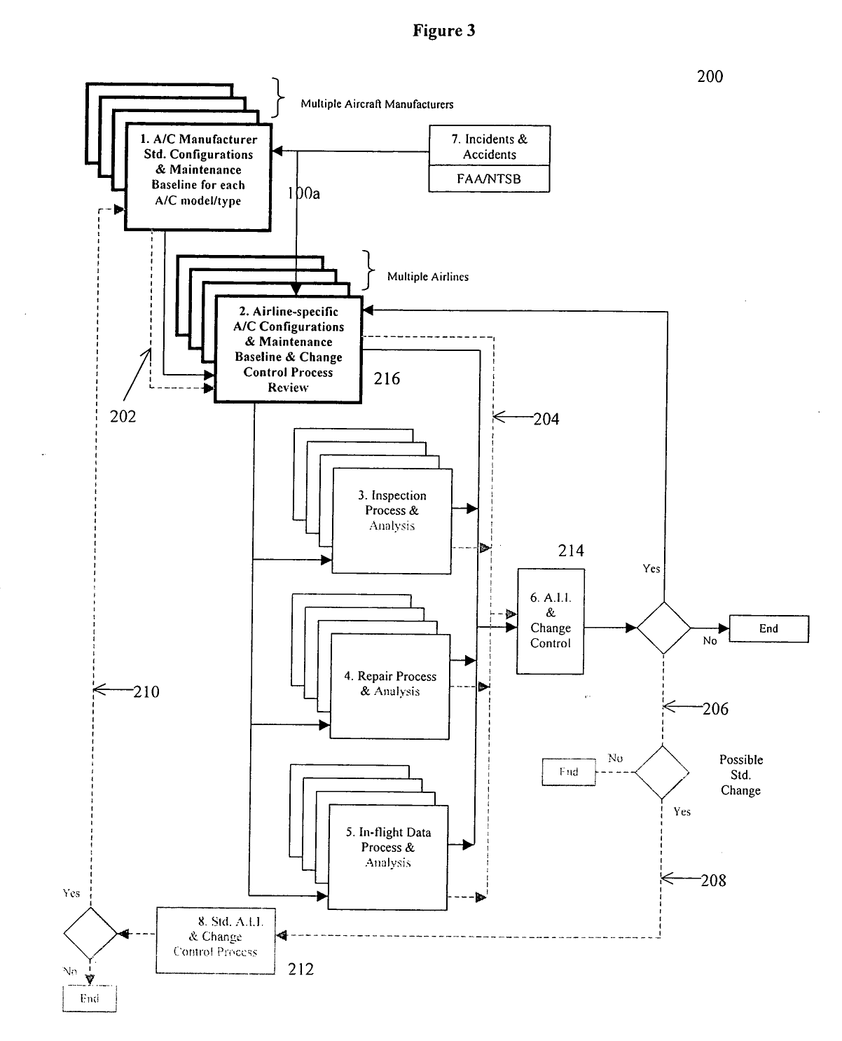

The method and process 200, FIG. 3, according to the present invention, is similar to the prior art process of FIG. 1 with the exception that this method depicts, for exemplary purposes, a multi-aircraft Manufacturer and multi-aircraft Maintenance Provider environment with the addition of information feedback loops 202-210 as a result of improvements and changes 212 to the control process in the Maintenance Baseline (also referred to as standard, neutered industry information) and the inspection, repair and in-flight processes in accordance with the teachings of the present invention. The revised maintenance standard 110a will be available to all appropriate users on-line and is a vital part of the repair and inspection process, ensuring that only current, updated and approved information 110a is used in the maintenance process. The continuous improvement of the Maintenance Baseline is accomplished through the continuous sharing of safety, reliability and productivity information across all users in a given user group of the system according to the present invention. This combined effort will ensure that each user group member will be operating with the latest, updated so-called standard information, thus avoiding problems that may occur without having such data.

Baseline improvement recommendations are processed through an Aircraft Improvement Initiative (AII) process 214 linked to an airline change control process 216 with the capabilities for a Maintenance Provider to share improvement ideas across the industry. These improvement recommendations are reviewed through a Standard AII (SAII) change control process 212 where they are evaluated and approved or disapproved and built into the Standard Baseline for distribution to all members who own the same type of aircraft/equipment. The present system and method will provide a feedback loop back to each affected AIMIS members providing an alert notice related to critical safety issues. Each airline will then evaluate each SAII for approval or disapproval into their Maintenance Baseline through their AII process. Thus, all airlines sharing safety and productivity data will allow the airline industry to move closer to its goal of becoming accident-free.

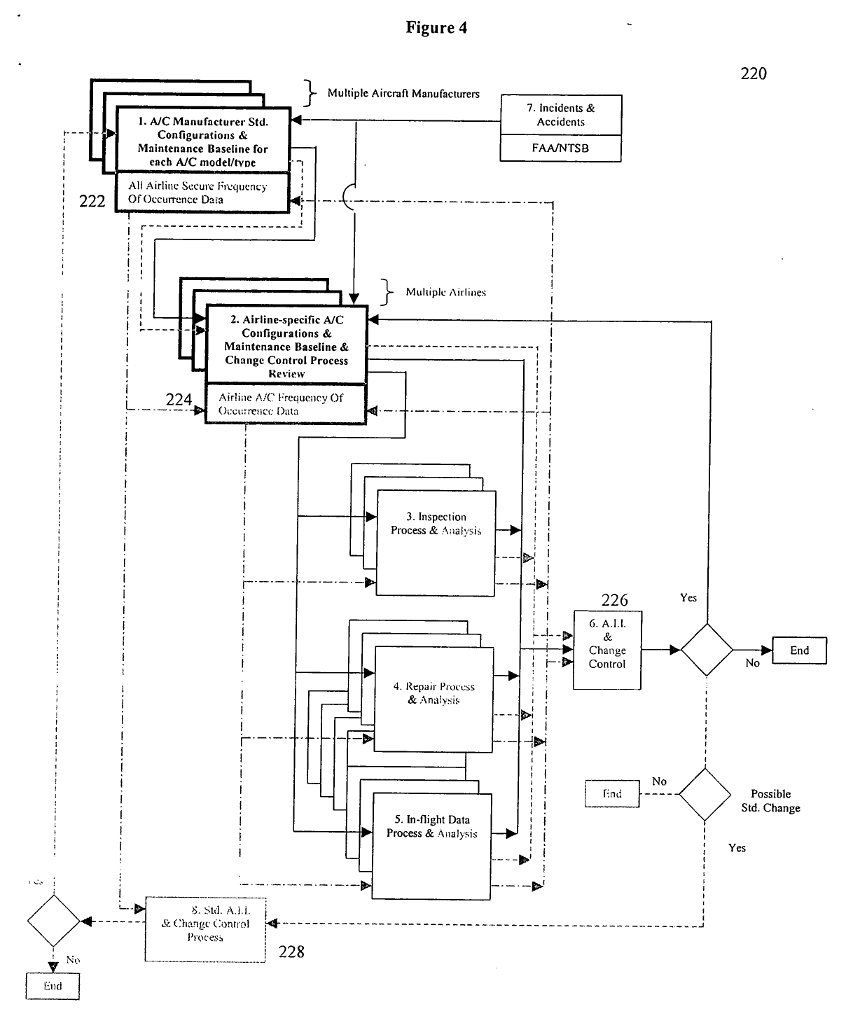

The Frequency-of-Occurrence Data Review and Update Process 220, FIG. 4, is similar to the process shown and described in FIG. 3. This process addresses the improvement to the inspection process through the use of wireless handheld computers in the like where Non-routine frequency-of-occurrence data is collected, stored and used as a part of the inspection and problem identification process. As with the sharing of Maintenance Baseline improvements, Non-routine data will be retrieved in a standard, structured format as a part of the inspection process downloaded first, from the Maintenance Provider's secure database 222, and second, from the system's user/manufacturer specific neutered Non-routine database 224. The combination of these data sources will greatly improve the quality of the inspection process. This is important from a Human Factors standpoint, considering the different experience levels of inspectors/mechanics and the availability of current inspection information. As a result of the Standard Baseline process, the inspector will now have the assurance that s/he is using the latest Baseline inspection task list/information. This will eliminate the possibility of an inspector or Maintenance Provider lacking the latest inspection tasks that may be known to or used by another Maintenance Provider(s), thus avoiding a critical, unsafe situation.

In an environment utilizing the present invention, an inspector/repair person will also have the latest internal, as well as worldwide, Non-routine data, allowing for a much higher quality level of fault detection. With the assurance of the latest known inspection tasks list and the like, an inspector will have available to him/her Historical Problems-Found and Frequency-of-occurrence data for a particular aircraft or piece of machinery, for all aircraft of that type within that airline and for all worldwide based aircraft for which data is provided and which utilize the system and method of the present invention. This will greatly improve the safety, quality and effectiveness of the inspection process identifying problems and related safety information that might not be known by an inspector or maintenance provider.

Frequency-of-occurrence data will then be analyzed and, where opportunities for improvement in safety, reliability and productivity exist, AIIs will be processed, act 226. The AII process is based on Six Sigma practices and includes root cause analysis, the development of best-in-class repair processes, test, certification and review and approval of the change to the Maintenance Baseline. As with improvements to the Standard Maintenance Baseline, Non-routine best-in-class repair processes will be processed through the Standard AII process 228 for inclusion into the Standard Baseline for possible use by all AIMIS members.

Systems Architecture and Systems Interfaces

The AIMIS Systems Architecture is broken down into three parts:
I. AIMIS Standard Maintenance Baseline System,
II. AIMIS Problems Found Frequency-of-Occurrence System, and
III. Remote Wireless on Line Access to and from AIMIS and AIMIS interfaces

AIMIS Standard Maintenance Baseline System

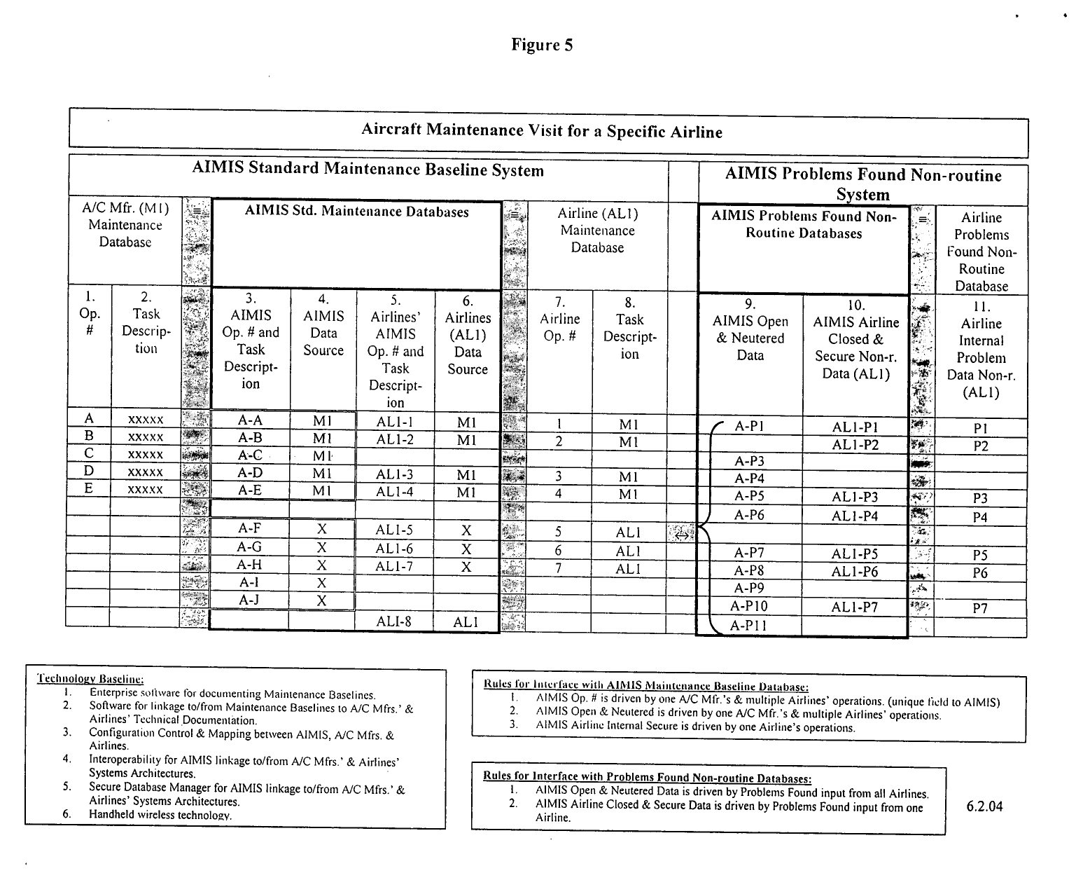

The AIMIS Standard Maintenance Baseline System, FIG. 5, and is comprised of three parts: The Aircraft Manufacturers' Maintenance Database, columns 1 & 2; the Standard AIMIS Maintenance Databases, columns 3, 4, 5 & 6, and the Airline Maintenance Database, columns 7 & 8. It should be noted again that this invention is not limited to the airline industry. The operability of the invention is presented in the airline industry context for illustration purposes only.

The AIMIS Standard Maintenance Baseline System has two critical features that must be present:

Interoperability

The AIMIS Standard Maintenance Databases are linked to the Aircraft Manufacturers' Maintenance Database and the Airlines' Maintenance Database through interoperability software.

Configuration and Change Control

All changes to the above AIMIS Baselines will be accomplished through formal Configuration and Change Control Procedures referred to by AIMIS as “Standard Aircraft Improvement Initiatives” (SAII) in the case of a proposed change to the Aircraft Manufacturers' Standard Maintenance Baseline and by an Aircraft Improvement Initiative (AII) for changes to a specific Airline's Maintenance Provider's Maintenance Baseline.

The Aircraft Manufacturers' Maintenance Database includes all maintenance inspection and repair tasks for a maintenance event and drives the Airline Maintenance Baseline as well as the AIMIS Baseline. It contains operation numbers, task descriptions and linkages to detailed technical documentation and drawings (reference columns 1 & 2).

The AIMIS Standard Maintenance Database (reference columns 3 & 4) may contain AIMIS capabilities and data elements that are not a part of the Aircraft Manufacturers' Database, thus minimizing any changes to the Aircraft Manufacturers' Systems Architecture, as a result of the implementation of AIMIS.

The AIMIS Standard Maintenance Database links columns 3 & 4 to the Aircraft Manufacturers' Maintenance Database, columns 1 & 2, at the task level (i.e. Aircraft Manufacturers' Task A is linked with the AIMIS Manufacturers' Task A-A, and includes linkages to the Aircraft Manufacturers' technical documentation). The AIMIS Standard Maintenance Database links columns 5 & 6 at the task level to the Airline Maintenance Database columns 7 & 8 (i.e. AIMIS Airline Task AL1-1 in column 5/row 1 is linked with Airline Op. Task 1 in column 6/row 1).

The Aircraft Manufacturers' portion of their Baseline in the AIMIS Standard Maintenance Database contains two parts:

Tasks identified by the Aircraft Manufacturer (reference column 3, Tasks A-A through A-E) and are linked to the Aircraft Manufacturers' Maintenance Database in column 1, Tasks A-E) and

As a result of the Standard Aircraft Improvement Initiative (SAII) process, tasks are added to the AIMIS Standard Maintenance Database (reference column 3, Tasks A-F through A-J). With these additions, but only after release by Maintenance Providers, unique maintenance tasks that may be of value to other Maintenance Providers from a quality, safety, reliability and productivity standpoint are included.

For example, new inspection and repair activities and new certified best-in-class repair instructions that may not a part of the A/C Manufacturers' Standard Maintenance Baseline. The Airline Maintenance Database includes all maintenance inspection and repair tasks for a maintenance event as defined by the Aircraft Manufacturer and the FAA, plus additional, airline-specific tasks as desired. It contains operation numbers, task descriptions and possible linkages to detailed technical documentation and drawings.

The Airline Maintenance Database may contain AIMIS capabilities and data elements that are not a part of the Maintenance Providers' current Systems Architecture, thus minimizing any changes to the Maintenance Providers' Systems Architecture as a result of the implementation of AIMIS. The secure unique Maintenance Providers AIMIS data would be accessible only by that Maintenance Provider.

AIMIS Problems Found Non-Routine System

The AIMIS Problems Found Non-Routine System will consist of two parts two parts:
A. AIMIS Problems Found Non-Routine Databases, columns 9 & 10 and
B. Airline Problems Found Non-Routine Database, column 11.

AIMIS Problems Found Non-Routine Databases (reference columns 9 & 10) are linked at the task level to the AIMIS Standard Maintenance Databases (reference columns 3 & 5) and to the Airline Problems Found Non-Routine Database (reference column 11). The AIMIS Problems Found Non-Routine Databases are comprised of two parts:
1. AIMIS Combined Neutered Problems Found Non-Routine Database
2. AIMIS Airline Secured Problems Found Non-Routine Database

AIMIS Combined Neutered Problems Found Non-Routine Database. For a specific aircraft model and type, the AIMIS Combined Neutered Problems Found Non-Routine Database (reference column 9) contains frequency-of-occurrence data for all problems found for that specific aircraft's model and type for all airlines at the inspection or routine task level (reference columns 3, 5 & 7). Note that the data in this database will be neutered to protect the identity of the specific airline or Maintenance Provider that found the problems. This is accomplished through the security aspect of the AIMIS Problems Found Non-Routine System.

The AIMIS Airline Secured Problems Found Non-Routine Database (reference column 10) contains the following: all problems found at the task level for a specific aircraft and for a specific maintenance visit (note: each task is either a unique inspection or repair activity.); the frequency-of-occurrence problems found at the task level for a specific aircraft's history of problems from all similar maintenance visits for that aircraft; and the frequency-of-occurrence problems found at the task level for that particular airline, aircraft type and model number, and specific type of visit. AIMIS would have the capabilities to identify like problems found between different types of Maintenance Visits providing cross-visits frequency-of-occurrence data.

The AIMIS Airline Secured Problems Found Non-Routine Database may contain capabilities and data elements that are not a part of the Maintenance Provider's current Systems Architecture, thus minimizing any changes to the Maintenance Provider's Systems Architecture as a result of implementing AIMIS, while still taking advantage of the AIMIS Problems Found Non-Routine System capabilities.

The AIMIS Problems Found Non-Routine System will be a part of online, wireless input-output capabilities of AIMIS, allowing the inspectors/mechanics to use this data at their place of work. The availability of this type of system will greatly improve the human factors component associated with the inspection process.

The Airline Problems Found Non-Routine Database (reference column 11) will be unique to each specific airline's Systems Architecture.

Interoperability

The AIMIS Problems Found Non-Routine System is linked to the AIMIS Standard Maintenance Baseline System and the Airline Problems Found Non-Routine Database through interoperability software.

Human Factors

Human Factors must be a strong consideration for any maintenance activity. First and foremost, the mechanic must have a high degree of confidence in the Maintenance Baseline. If this is not the case the mechanic must always second-guess the Maintenance Baseline and rely on his/her own experience. The problem here is that not all mechanics have the same level of experience, which has in the past created serious problems.

Another important consideration is the availability of needed current and correct information at the place of work, including current certified inspection and repair instruction and access to detail documentation, as well as problem-related frequency-of-occurrence data from both internal as well as external sources.

With a strong emphasis on human factors engineering, AIMIS will provide state-of-the-art, wireless, on-line data access and update capabilities at the place of work.

Data Structure

An exemplary data structure utilized by the present invention is based on the Aircraft Manufacturers' Standard Maintenance Planning Data Document, which serves as the common maintenance base for all Airlines and Third Party Maintenance Providers. The present invention recognizes that while each airline may structure its maintenance process differently, the common linkage will occur at the routine or inspection task level. Thus, the invention will allow for unique, airline-specific tasks. Airlines can choose to make these airline-specific tasks available to other AIMIS members through the Standard Aircraft Improvement Initiatives (SAII) process, considering the potential impact on safety, reliability, quality and operational effectiveness.

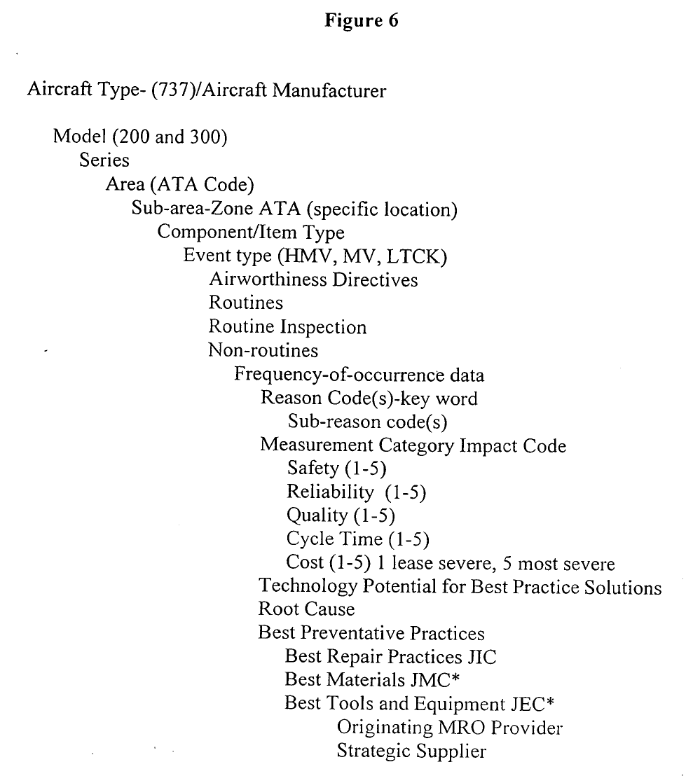

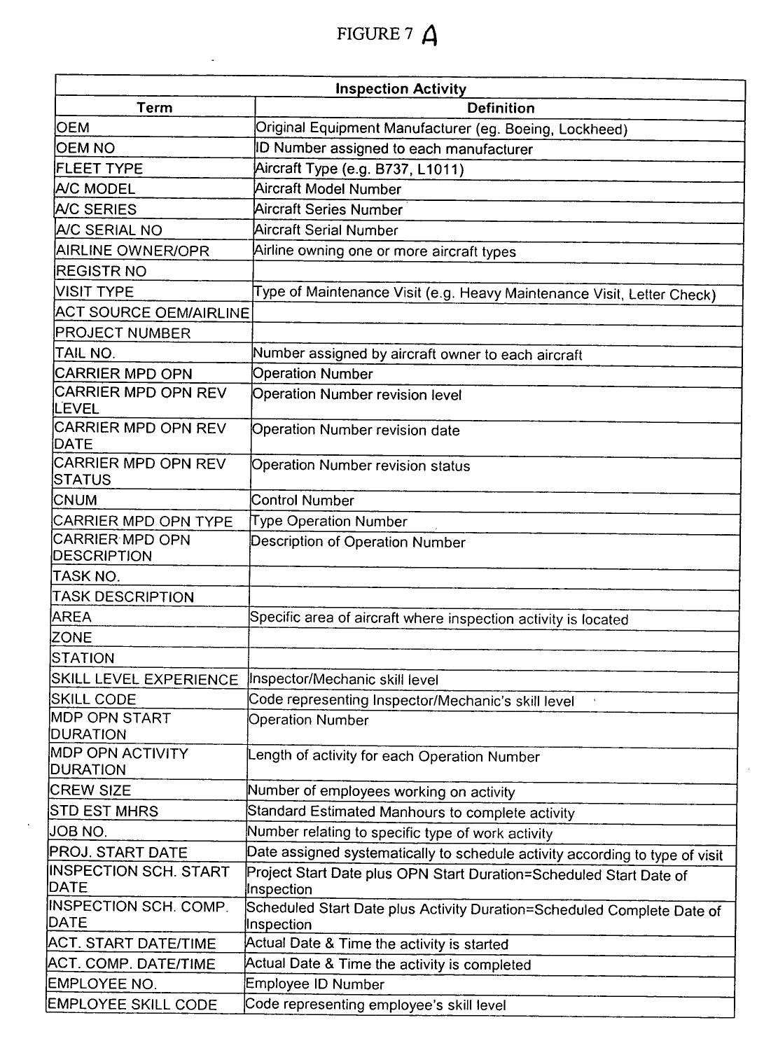

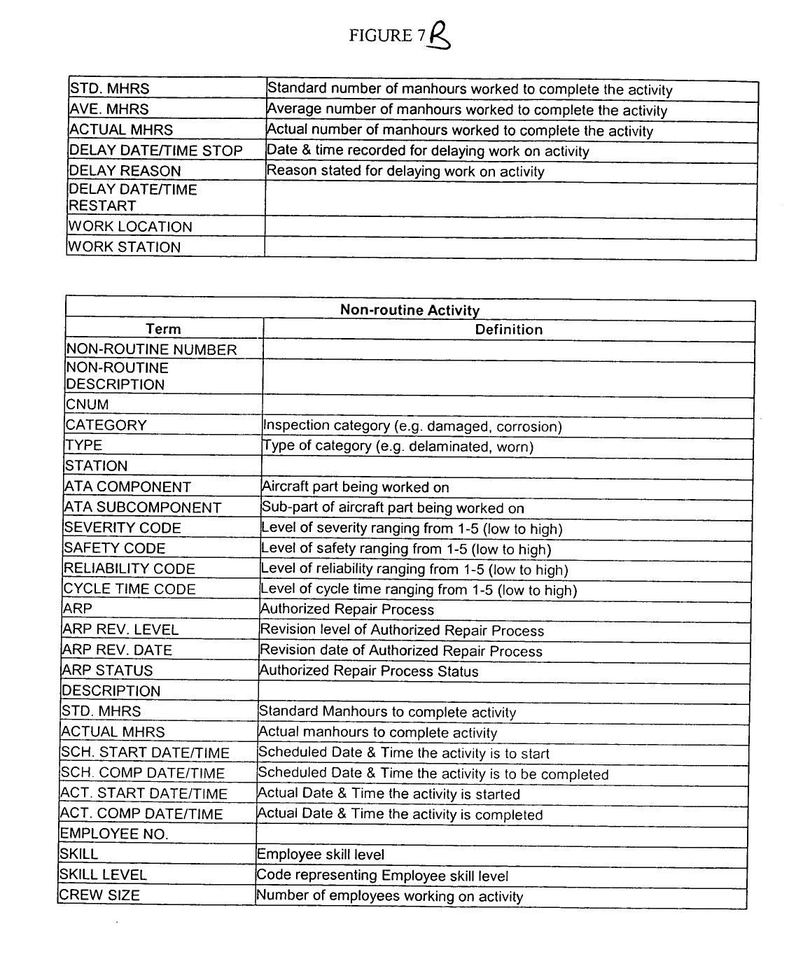

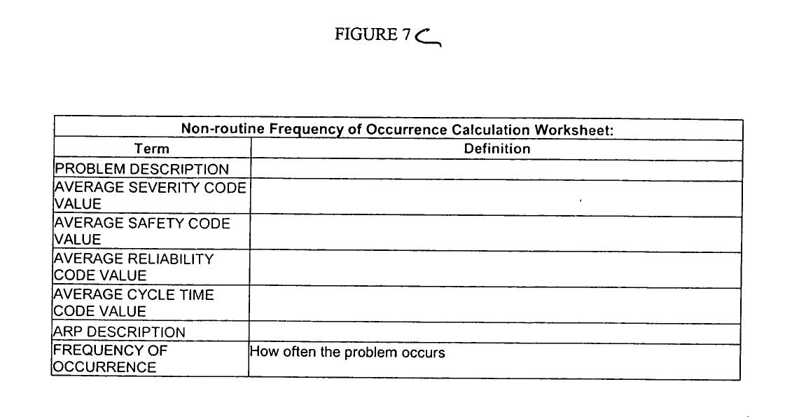

A generic data structure which can be used in connection with the present invention is illustrated in FIG. 6 and in FIGS. 7A-7C which contain a partial and exemplary list of key data elements regarding AIMIS inspection, repair and problems-found as well as frequency-of-occurrence processes. This list is provided as an example of types of information that can be in the AIMIS Systems Architecture and is not to be considered final or complete.

The content and data structure of AIMIS is critical to its operational effectiveness. Human factors must play an important role to make AIMIS useful and easy to use. Working with Aircraft Manufacturers and Maintenance Providers, system designers and implementers will agree upon the standard AIMIS content and data definition of the AIMIS database. AIMIS Aircraft Manufacturers and Maintenance Providers can have their own AIMIS-specific, secure data structure. Linkage between the AIMIS Systems Architecture and AIMIS members' Systems Architecture will be through interoperability software.

The AIMIS data structure is based on the Aircraft Manufacturers' or Original Equipment Manufacturers' (OEM's) Maintenance Planning Documents and serves as the common base for all Airlines' and Third Party Maintenance Providers' maintenance programs. AIMIS recognizes that while each airline may structure its maintenance process differently, the common linkage will occur at the A/C (Type/Model) task level. AIMIS will allow for unique, airline-specific tasks that can be made available to other airlines, considering the potential impact on safety, reliability, quality and operational effectiveness.

Data Retrieval and Reporting

System Data Retrieval and Reporting process is comprised of five parts: Baseline Standardization; Inspection and Repair Process; Non-routine Repair Planning Process; Non-routine Repair Process; and Data Analysis and Authorized Repair Process (Aircraft Improvement Initiative AII).

Through the feedback of AIIs and S/AIIs from a worldwide perspective, the AIMIS process and systems will provide the mechanism for all Aircraft Manufacturers, Airlines and third-party Maintenance Providers with the opportunity to have the latest maintenance baseline information. This will allow all AIMIS partners to benchmark their current Maintenance Baselines with the current AIMIS Aircraft Manufacturer's Standard Maintenance Baseline, which will have been under continuous improvement by S/AIIs from all other AIMIS members. Based upon this comparison the airlines have the opportunity to upgrade their Baselines by processing AIIs.

AIMIS will also allow an airline to make a direct comparison of their Non-routines to AIMIS Non-routine data from all other maintenance providers. This comparison will allow the airlines to analyze the effectiveness of their maintenance processes, identifying opportunities for improvement.

Inspection and Repair Process

It should be noted that a very similar process will be used for routine repair work in that for a specific repair activity, problems can be researched using AIMIS Systems Architecture capabilities.

The AIMIS environment will provide an inspector with a list of Inspection Activities based on a Critical Path Schedule or other priority code. Note: Major types of transactions are as follows:

The first transaction type in the Inspection Screen will allow the Inspector to select a group of Inspection Activities from an Inspection Job Queue Table. Note: The Inspection Job Queue Table is based on the Airlines' Standard Maintenance Baseline. This queue table will have inspection tasks records listed by Critical Path Schedule. A unique inspection task operation number will identify inspection tasks records.

When a queue record is chosen, it will be linked with the Inspection Task Master List by inspection tasks number to pull in the detailed inspection tasks associated with that Inspection Activity—those tasks will be displayed in a grid on the entry screen. Information from the Inspection Job Queue Table (dates, time, tail number, project number, inspector, etc. will also be displayed in the Inspection Task Master List screen.

The inspector can double-click one of the inspection tasks from the Inspection Task Master List screen and an Event Problem Detail Screen will appear. This Event Problem Detail Screen will have three buttons for Problem History by aircraft tail number, fleet model/type for a specific airline and all airlines (neutered data) for a fleet model type for that particular inspection task. Pushing these buttons will result in a pop-up window that will allow the user to search the Internal Problem History Table and External Problem History Table.

The Internal Problem History Table will contain all inspection finds (problems or Non-routines) listed in order of frequency-of-occurrence for those particular inspection tasks as found by internal inspectors based upon previous inspections for an individual aircraft or for all internal aircraft for the same fleet model type. As an example, each problem will identify the Component/Subcomponent, Category and Type of Problem and the range and average for each of the five Impact Codes (severity, safety, reliability, cost and cycle time using a scale of 1 to 5, 5 being most severe). Linkage to root cause analysis and best-in-class repair processes, if available, will also be available.

The inspector also has the option to investigate problems found by other Maintenance Providers who are a part of the AIMIS Team by clicking on the External Problem History Table. In this case similar information will be displayed as with the Internal Problem History Table except that this information will identify problems found in a neutered manner by all other Maintenance Providers who are members of the AIMIS Team or system. This type of information provides immediate information to an inspection item of which the inspector might not be aware, greatly improving safety and quality of the inspection process. Maintenance Providers will not be identified since their specific data will be secure. The inspector will know that the problems/Non-routines occurred, but will not know on which airline they occurred. Note: The Internal Problem History Table and the External Problem History Table files used for this Inspection Activity will be saved as a baseline for future analysis as may be required.

In the event that the Inspector identifies an actual problem that is identified on the Internal Problem History Table, the Inspector will double-click on that item. Then the fields from the Internal Problem History Table will populate the Event Problem Detail Screen from the chosen problem. The same process will occur for problems that are identified on the External Problem History Table. In either case the lower part of the Event Problem Detail Screen will include Impact Codes (severity, safety, reliability, cost and cycle time) in a scale of 1 to 5, 5 being most severe. Based upon the observance of the problem the severity of each of these Impact Codes will be updated. The Inspector will repeat this process by scrolling through the Internal Problem History Table and the External Problem History Table screens to ensure all noted problems have been reviewed for a possible occurrence.

In the event that a problem is found that is not on the Internal Problem History Table or the External Problem History Table screens, the lower part of the Event Problem Detail Screen will include pop-up fields for Category, Type, Location, Component or Subcomponent. These fields can be filtered based on the inspection task chosen—each will have its own table. There will also be Impact Codes (severity, safety, reliability, cost and cycle time) in a scale of 1 to 5, 5 being most severe, which will be updated by the Inspector. In addition an open text field will be available to describe the new problem that was found where the above filters are not adequate. Care will be taken to ensure consistency of the problem definition by the category type, component and subcomponent codes. New problems found will be identified and the date found recorded for further analysis.

Once an inspection task is completed the Inspector will indicate that the inspection task is complete and move to the next inspection task on the Inspection Task Master List and repeat the process until all of the inspection tasks for that Inspection Activity are complete. Once the Inspection Activity is complete (all inspection tasks have been investigated) the Inspector will identify that Inspection Activity is complete by pushing the “Inspection Complete” button from the Inspection Screen. Recorded information on the Event Problem Detail Screen will be used to update the airline and AIMIS problem (Non-routine) history files both internal to that Maintenance Provider and the neutered AIMIS Non-routine databases for that specific event. The inspector will move to the next Inspection Activity as identified on the Inspection Job Queue Table, and the same process will be followed until all Inspection Activities have been completed for that event. Electronic signature capabilities will be provided identifying the inspectors/mechanics who completed the inspection task.

In the event of any delays in the inspection process, an inspector can hit the “Save Incomplete” button that will record the time that the inspection process was stopped, the reason for the stoppage and the point in the inspection process where the inspection was stopped. This information will be displayed on the Inspection Job Queue Planning Screen and that inspection task will be identified as “IC”. If it is expected that the inspection task will be delayed for an extended amount of time, the inspector has the option to update the planned completion date, indicating the reason for the delay. Once the inspection process is restarted, the start time will be recorded. Inspection Transactions can be modified through a Transaction Modification function, which will be controlled by Policy and Procedure.

Non-Routine Repair Planning Process

As Inspection Activities are completed, the associated Non-routines will be registered on a Non-routine Repair Job Queue Planning Screen. This screen will include the information recorded by the inspector plus information as to whether or not a Root Cause Analysis and Authorized Repair Process exist. A Lead Mechanic will then update the Non-routine Repair Job Queue Planning Screen with planned start and complete dates using a Critical Path Schedule. This schedule will then be used by mechanics to plan their Non-routine repair activities.

Non-Routine Repairs Process

Choosing the Repair Transaction Type will bring up the Non-routine Repair Job Queue and the Non-routine Repair Job Queue Planning Screen. The Non-routine Repair Job Queue Planning Screen will allow the mechanic to select a non-routine item from the Non-routine Repair Job Queue Planning Screen. This queue table will have the inspection number and description from which the non-routine was generated and indicate whether or not a Root Cause Analysis and/or Authorized Repair Process exist.

When the queued record is chosen, a mechanic can click on the Root Cause or Authorized Repair Process keys, and Root Cause Analysis information and the Authorized Repair information (i.e., repair instructions, needed materials, equipment and tool information) can be retrieved. When the mechanic actually begins the work on this Non-routine, s/he will push the Start Activity button and the time that the repair process began will be recorded, as well as other critical control data (i.e. mechanic's name, number, skill level, etc.). This will update the Non-routine Repair Job Queue Planning Screen indicating that the repair process has begun and the start time will be recorded. For those queued records that have no Root Cause Analysis or Authorized Repair Process the mechanic will work through established procedures to obtain an Authorized Repair Process.

As individual items on the inspection task are completed, the mechanic will click on the complete boxes indicating that that activity has been completed. Similarly, on the materials used screen the mechanic will click on the materials used boxes. As a part of the repair process, when equipment is returned to the tool shed, the mechanic will update the equipment/tools used screen by clicking on the tools returned box.

Once the repair process is completed the mechanic will touch the “Repair Complete” button. This will indicate that the Non-routine is complete (“CP”) and the system will record the time that the repair was completed. This will update the Non-routine Repair Job Queue Planning Screen indicating that that repair item has been completed, recording the time that it was completed and indicating that the item is ready for inspection.

In the event of any delay or other lack of completion of the job, a mechanic can hit the “Save Incomplete” button that will record the time that the repair process was stopped and the reason for the stoppage. This information will be displayed on the Non-routine Repair Job Queue Planning Screen and that repair item will be identified as “IC”. If the item is expected to be delayed for an extended period of time, the mechanic has the option to update the planned completion date, indicating the reason for the delay. Once the repair process is restarted, the start time will be recorded.

Repair Records can be modified through the Modification function, which will be controlled by Policy and Procedure.

As repair items are completed and the Non-routine Repair Job Queue Planning Screen is updated an Inspector will use this screen to schedule the inspection of the completed repairs, where required. Electronic signature capabilities will be provided identifying the mechanic(s) completing the work. If the Inspector indicates that the repair process was completed satisfactorily s/he will update the Non-routine Repair Job Queue Planning Screen status to “approved” and record the date and time. Again electronic signature capabilities will be provided identifying the authorizing inspector. If there were problems with the repair process the Inspector will update the Non-routine Repair Job Queue Planning Screen, indicating that the item was rejected and recording the date and time of rejections, indicating that additional repair activity is required. It should be noted that the routine repair process will be similar to non-routine repair process with the exception that the repair activity will be routine.

Problem Analysis and Best Practices Solutions

The AIMIS database design will be secure for a specific airline's data, but will provide combined, secure data and information from many airline sources, which will be neutered, and like information combined, such that one airline or other AIMIS member will not have access to another airline's specific data. The AIMIS database will have flexible sorting capabilities allowing for sorting of data in any manner. Any AIMIS member (i.e. Airline, Third Party Maintenance Provider, Aircraft Manufacturer/OEM or Strategic Supplier) will have access to the data for data mining purposes.

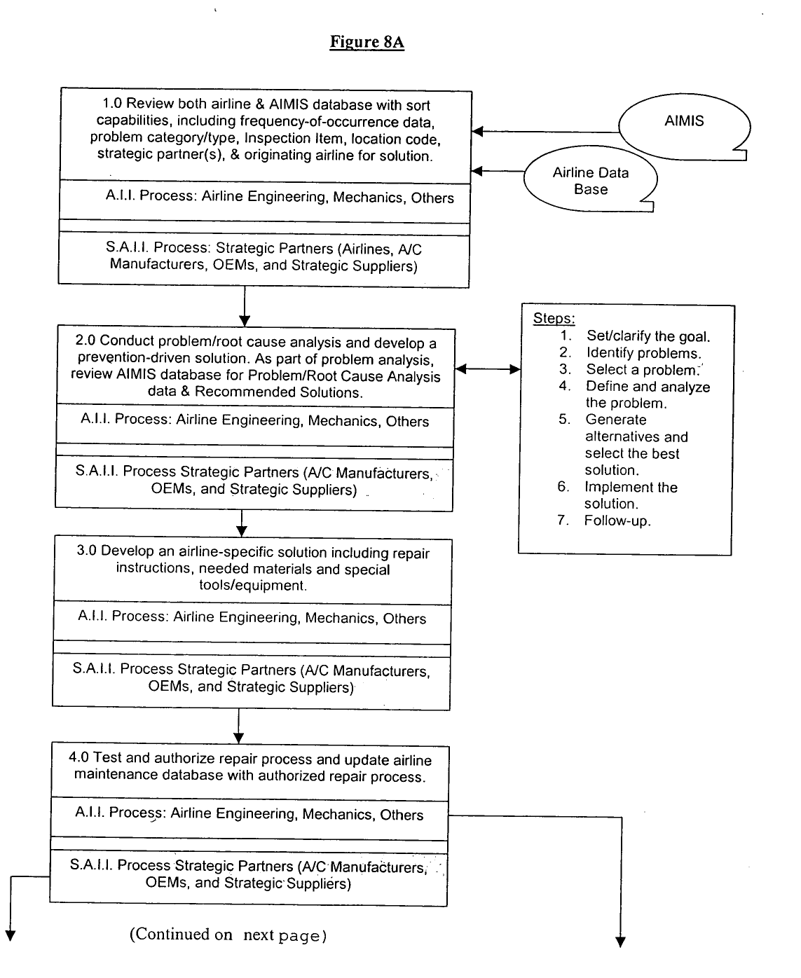

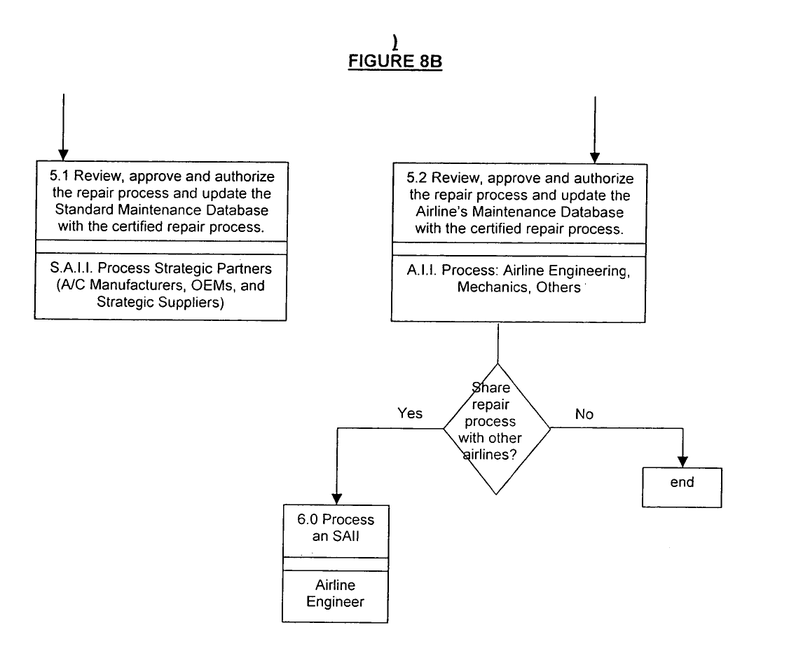

The AIMIS analysis will have many purposes. Its primary purpose is to identify opportunities to improve safety, reliability, quality and productivity through Standard/Aircraft Improvement Initiatives (SAIIs/AIIs). FIGS. 8A and 8B identify an exemplary Data Analysis and Authorized Repair Process Standard/Aircraft Improvement Initiatives (SAIIs) process and is provided as a guide for the discussion that follows.

The Standard/Aircraft Improvement Initiative (S/AII) process is a process or guideline by which opportunities identified as a result of the review of the Maintenance Baseline and/or analysis of the AIMIS databases or other opportunities can be managed through a Six Sigma based process including root cause analysis and the development and authorization of certified best-in-class repair processes. It should be noted that any AIMIS member, including an Airline, Aircraft Manufacturer, Original Equipment Manufacturer (OEM) or Strategic Supplier can initiate an S/AII.

The S/AII processes includes the following phases:
Phase 1: AII Initiation, Baseline and Authorization (Why do it)
Phase 2: Problem\Root Cause Analysis
Phase 3: AII Solution Development
   3A Design Development
   3B Detailed Analysis
   3C Process Development
Phase 4: Production Procurement
Phase 5: Training
Phase 6: Acceptance Testing and Certification
Phase 7: Implementation/Operation
Phase 8: Post Implementation Audit

Using opportunities identified by the S/AII process, S/AII teams will conduct a root cause analysis and develop prevention-driven, best-in-class repair processes. At the end of each S/AII process step, there will be a technical, as well as a project, review. The technical review will critically examine the technical feasibility of the proposed solution with the ultimate test being the Supplemental Type Certification as required.

Project reviews will ensure that schedules and budgets are within targeted guidelines. At the end of each phase, the ROI (Return On Investment) for the Airline and Strategic Supplier will be updated to ensure the continued economic feasibility of the project.

Accordingly, the present invention discloses and claims a system and method that may be used across nearly any industry that is susceptible to repair and maintenance of equipment. The present system and method allows equipment Manufacturers and users to begin with a set procedure or method for equipment repair, checkup and maintenance will allowing in the fields and/or in-service experience to be incorporated in and modify the set procedures. Information gathered from many sources including field repairs, failure analysis by third parties, supplier information and the like is evaluated for its potential impact on equipment repair and maintenance and, if applicable, used to update the equipment's set maintenance repair procedures and of inspection. While this process of gathering data is currently performed by individual airlines, the present invention will allow for the neutered and secure sharing of that data among all AIMIS members.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with the breadth to which they are fairly, legally and equitably entitled.

1. A system for coordinating product routine repair, inspection, non-routine repair and maintenance, comprising:
a source of standardized product repair and inspection information;
a source of non-standardized product information; and
a processing system, responsive to said source of standardized product repair and inspection information and said non-standardized product information, for analyzing said non-standardized product information and for providing change information to said standardized product information based on said non-standardized product information thereby providing updated standardized information.

2. The system of claim 1 wherein said source of standardized product information includes routine repair, inspection and maintenance information.

3. The system of claim 1 wherein said source of non-standardized product information includes inspection, non-routine repair and maintenance information.

4. The system of claim 1 further including a plurality of users having access to said source of standardized product information.

5. The system of claim 4 wherein said source of non-standardized product information includes said plurality of users.

6. The system of claim 1 wherein said processing system analyzes said non-standardized product information against said standardized product information.

7. The system of claim 1 wherein said non-standardized product information includes accident information, frequency of occurrence information, repair information and in-service problem information.

8. The system of claim 5 wherein said plurality of users provide user non-standardized product information.

9. The system of claim 8 wherein said non-standardized product information includes repair information, in-service problem information, product repair guideline information and observation information.

10. A system for coordinating product inspection, repair and maintenance, comprising:
a source of standardized product information;
a source of non-standardized product information
a plurality of users having access to said source of standardized product information and for providing user non-standardized product information; and
a processing system, responsive to said source of standardized product information, said non-standardized product information and said user non-standardized product information, for analyzing said non-standardized product information and said user non-standardized product information against said standardized product information, and for providing change information to said standardized product information based on said non-standardized product information thereby providing updated standardized information.

11. A method for coordinating product inspection, repair and maintenance, comprising the acts of:
providing a source of standardized product information;
providing a source of non-standardized product information; and
responsive to said source of standardized product information and said non-standardized product information, analyzing said non-standardized product information and providing change information to said standardized product information based on said non-standardized product information thereby providing updated standardized information.

12. The method of claim number 11 wherein said source of standardized product information includes inspection, repair and maintenance information.

13. The method of claim 11 wherein said source of non-standardized product information includes inspection, repair and maintenance information.

14. The method of claim 11 further including a plurality of users having access to said source of standardized product information.

15. The method of claim 14 wherein said source of non-standardized product information includes said plurality of users.

16. The method of claim 11 wherein said processing system analyzes said non-standardized product information against said standardized product information.

17. The method of claim 11 wherein said non-standardized product information includes accident information, frequency of occurrence information, repair information and in-service problem information.

18. The method of claim 15 wherein said plurality of users provide user non-standardized product information.

19. The method of claim 18 wherein said non-standardized product information includes repair information, in-service problem information, product repair guideline information and observation information.
